(19) United States
(12) Patent Application Publication
(10) Pub. No.: US 2009/0281994 A1
(43) Pub. Date: Nov. 12, 2009

(54) Interactive Search Result System, and Method Therefor

(76) Inventor: Robert V. Byron, Plano, TX (US)

Correspondence Address: CARSTENS & CAHOON, LLP, P O BOX 802334, DALLAS, TX, 75380, US

(21) Appl. No.: 12/118,614

(22) Filed: May 9, 2008

(51) Int. Cl. G06F 7/06; G06F 17/30

(52) U.S. Cl. 707/3; 707/E17.014

(57) ABSTRACT

A system and method to provide interactive search results, wherein interactive icons allow a user to customize displayed search results, thereby providing the user with a robust, tailored environment for providing relevant search results.

### FIELD OF THE INVENTION

The present invention is generally related to web-based search engines, and more specifically to web-based search engine result rendering.

### BACKGROUND OF THE INVENTION

There exist several methodologies for performing web-based searches for user-supplied search terms. The goal, regardless of algorithm or technique, is to provide the most relevant search results possible. This task has become increasingly difficult given the dearth of data that exists.

### SUMMARY OF INVENTION

The present invention achieves technical advantages as a system and method to provide interactive search results. One preferred embodiment of the invention utilizes interactive icons to allow a user to customize displayed search results; thereby providing the user with a robust, tailored environment providing more relevant search results.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 exemplifies a diagram of an interactive search result system for providing user-defined custom search results, in accordance with principles of the present invention;

FIG. 2 exemplifies a diagram of a method for providing interactive search results, in accordance with principles of the present invention; and

FIG. 3 exemplifies a diagram of a method for customizing search results, in accordance with principles of the present invention.

### DETAILED DESCRIPTION OF THE PRESENT INVENTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, web-based search engines, and the like have been omitted inasmuch as such details are not considered necessary to obtain a complete understanding of the present invention, and are considered to be within the skills of persons of ordinary skill in the relevant art.

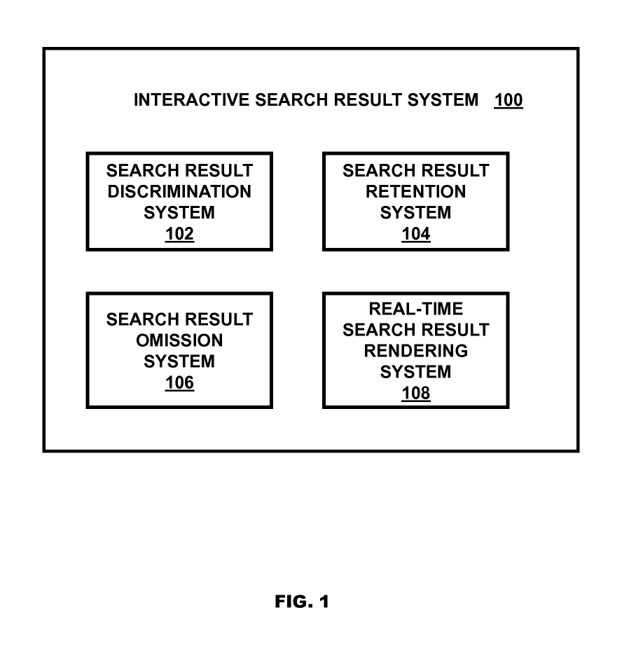

Referring to FIG. 1, there is shown at 100 a diagram of an interactive web-based search result system for providing user-defined custom search results from the Internet in accordance with principles of the present invention. System 100 is preferably implemented in hardware, software, or a suitable combination of hardware and software thereof and may comprise one or more software systems operating on a digital signal processing platform or other suitable processing platforms. As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a web-based network, such as the Internet, considered to be well-known in the art. As used herein, “software” can include one or more objects, agents, threads, lines of code, subroutines, separate software applications, two or more lines of code or other suitable software structures operating in two or more software applications or on two or more processors, or other suitable hardware structures. Furthermore, it is considered that the design, development, and implementation details of all such hardware and software would be apparent to a person having ordinary skill in the art based upon a review of the present description of the invention. In one preferred embodiment, software can include one or more lines of code or other suitable software structures operating in a general purpose software application, such as an operating system, and one or more lines of code or other suitable software structures operating in a specific purpose software application.

System 100 includes search result discrimination system 102, search result retention system 104, search result omission system 106, and real-time search result rendering system 108.

The system 100 is adapted to receive the results of searches conducted on the Internet, and to save the search results obtained thereof. Search result discrimination system 102 is adapted to customize the search results by storing and manipulating a Uniform Resource Locator (URL) associated with a specific search result retrieved from the Internet through interactive icons. In one embodiment, a user can click on a hyperlinked icon to store the associated URL in a network location. Search result discrimination system 102 can include web sites, blogs, forums, news feeds and other suitable Internet resources that can be used to provide search results. In a second embodiment of the invention, search result discrimination system 102 can be populated utilizing search engine results, web crawler results, manual selection, or in other suitable manners retrieved from the Internet. The search result discrimination system 102 population can be achieved with an application programming interface (API), HTML, DHTML, JavaScript, Dojo, Ruby, Rails, other suitable applications, or a suitable combination thereof.

Search result retention system 104 is adapted to save the URL associated by the system 102 with the specific search result for future retrieval by storing the URL in a network location. In one embodiment of the invention, the function of the search result retention system 104 is achieved with an API, HTML, DHTML, JavaScript, Dojo, Ruby, Rails, other suitable applications, or a suitable combination thereof.

Search result omission system 106 is adapted to delete the URL associated with a specific search result and omit it from future searches by storing the URL to a network location. In one embodiment of the invention, the function of the search result omission system 106 is achieved with an API, HTML, DHTML, JavaScript, Dojo, Ruby, Rails, other suitable applications, or a suitable combination thereof.

Real-time search result rendering system 108 is adapted to customize search results as defined by user-specified filters and render the customized search results in a web browser. In one embodiment, the search results are customized by showing or removing search results that have been previously identified as desirable or undesirable. In a second embodiment, the user-specified filters are URLs or tags. In a third embodiment, the function of the real-time search result rendering system 108 can be achieved with an API, HTML, DHTML, JavaScript, Dojo, Ruby, Rails, other suitable applications, or a suitable combination thereof.

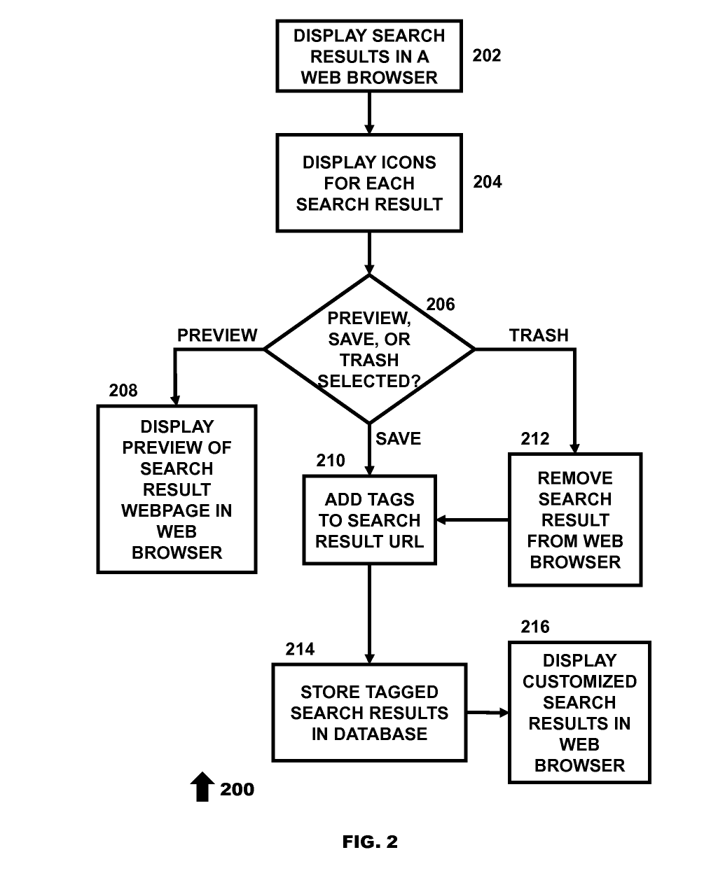

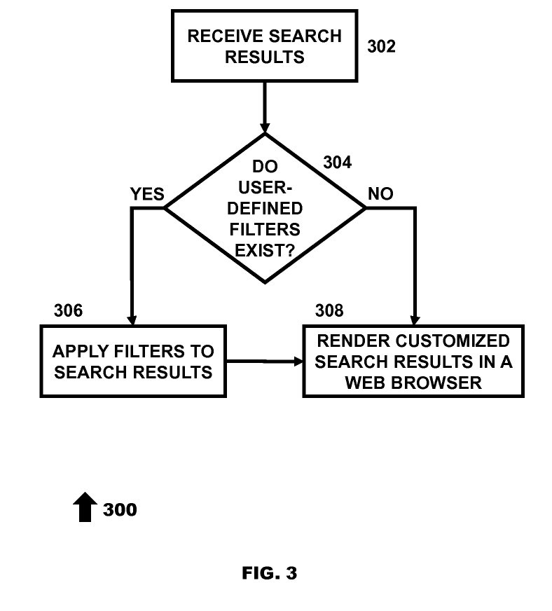

As discussed in further detail below with respect to FIGS. 2 and 3, in operation, system 100 provides interactive search results by identifying URLs that a user has previously disregarded, eliminating search result URLs the user has previously identified as undesirable, and rendering the customized search results to the user. System 100 thus provides customized searching through the use of interactive icons.

Referring now to FIG. 2, there is shown at 200 a flow chart exemplifying control logic embodying features of a method of the present invention for providing interactive search results in accordance with an one preferred embodiment of the present invention. Method 200 can be implemented as an algorithm on a general purpose computing platform or other suitable system.

Method 200 begins at 202, where search results are displayed in a web browser. The method then proceeds to 204.

At 204, each search result is assigned icons in order to manipulate the search result. In one preferred embodiment, a preview icon, a save icon, and a trash icon are assigned to each search result. The method then proceeds to 206.

At 206, it is determined whether the preview icon, save icon, or trash icon was selected by the user for a specific search result. If the user selected the preview icon, the method proceeds to 208. If the user selected the save icon, the method proceeds to 210. If the user selected the trash icon, the method proceeds to 212.

At 208, the search result webpage is opened in a preview area within the web browser. In one preferred embodiment, the preview area is disposed over the search results and includes two icons, one to render the search result website in its own browser window, and one to close the search result preview area.

At 212, when the trash icon of a search result is selected by a user, that search result is removed from the search results displayed in the web browser. In one preferred embodiment, a graphic of the search result moves from the search result location to a trash icon. The method then proceeds to 210.

At 210, the affected search result is tagged with relevant information. In one preferred embodiment, the tags are a timestamp, a category, and other suitable tags. The method proceeds to 214.

At 214, the tagged search results are saved in a network location. Furthermore, when the save icon of a search result is selected by a user, that search result is tagged and then stored in the network location. In one preferred embodiment, a graphic of the search result moves from the search result location to a save icon, yet remains in the search results displayed in the web browser. In one preferred embodiment, a user can log into an environment where their saves and trashes can persist indefinitely to build a highly customized search environment that evolves with the user's interaction. The method then proceeds to 216.

At 216, the customized search results are displayed in the web browser.

Referring now to FIG. 3, there is shown at 300 a flow chart exemplifying control logic embodying features of a method of the present invention for customizing search results in accordance with one preferred embodiment of the present invention. Method 300 can be implemented as an algorithm on a general purpose computing platform or other suitable system.

Method 300 begins at 302, where search results are received from a search engine. The method then proceeds to 304.

At 304, it is determined whether user-defined filters exist. In one preferred embodiment, the user-defined filters are URLs and/or tags. The user-defined filters exist in a network location. The method then proceeds to 306.

At 306, the user-defined search result filters are applied to the search results. In one preferred embodiment, the user-defined search result filters are applied to the search results by omitting search results with URLs that match stored URLs tagged as trash. In a second preferred embodiment, the user-defined search result filters are applied to the search results by omitting search results with keywords that match stored keywords tagged as trash. The method then proceeds to 308.

At 308, customized search results are rendered to the user in a web browser.

The present invention derives technical advantages because first, other solutions can't discriminate search results using a URL associated with a specific search result through interactive icons. Advantageously, the URL may be modified to include an entire domain name, or a subdirectory located in that URL.

The present invention achieves further technical advantages by providing visual cues and databases to users to simplify the process and provide intuition to complex data processing.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. An interactive search result system, comprising:
a search result discrimination system adapted to customize one or more search results by storing and manipulating a Uniform Resource Locator (URL) associated with a specific one of the one or more search results through interactive icons;
a search result retention system adapted to save the URL associated with the specific one of said one or more search results for future retrieval by storing the URL in a network location;
a search result omission system adapted to delete the URL associated with the one of said one or more specific search results and omit it from future searches by storing the URL to a network location; and
a real-time search result rendering system adapted to customize search results as defined by user-specified filters and render the customized search results in a web browser.

2. The system of claim 1, wherein a user can log into the interactive search result system to persist the search result customization.

3. The system of claim 1, wherein the stored URL can be manually edited before saving.

4. The system of claim 1, wherein the network location is a database.

5. The system of claim 4, wherein the database is located on a local host.

6. The system of claim 4, wherein the database is a network asset.

7. The system of claim 1, wherein the URL is tagged before it is saved.

8. The system of claim 7, wherein the URL is tagged with a timestamp.

9. The system of claim 7, wherein the URL is tagged with a category.

10. The system of claim 1, wherein the user-defined filters are the tagged URLs located in the network location.

11. The system of claim 10, wherein the search result URLs that match the trash URLs are omitted from the search results rendered in the web browser.

12. A method for providing interactive search results, comprising:
displaying one or more icons for each search result in a web browser;
previewing a search result webpage in the web browser containing the search results by selecting a preview icon associated with the search result webpage;
saving a search result by selecting a save icon associated with the search result;
deleting a search result by selecting a delete icon associated with the search result;
tagging user-specified search results and storing the user-specified search results to a network location; and
displaying customized search results in the web browser.

13. The method of claim 12, wherein the webpage is previewed in a webpage preview area disposed within the search results in the web browser.

14. The method of claim 13, wherein the preview area contains icons for displaying the webpage in its own web browser.

15. The method of claim 13, wherein the webpage preview area contains an icon for closing the webpage preview area disposed within the web browser.

16. The method of claim 12, further comprising logging into an interactive search result system to persist customization.

17. The method of claim 12, wherein the save icon stores a Uniform Resource Locator (URL) associated with the search result.

18. The method of claim 17, wherein the URL can be edited before saving.

19. The method of claim 12, wherein the network location is a database.

20. A method for customizing search results, comprising:
receiving search results;
determining whether user-defined search result filters exist;
applying the user-defined search result filters to the search results; and
rendering customized search results in a web browser.

21. The method of claim 20, wherein the user-defined filters are tagged Uniform Resource Locators (URLs).

22. The method of claim 20, wherein the user-defined search result filters are located in a network location.

23. The method of claim 20, wherein the user-defined search result filters are applied to the search results by omitting search results with URLs that match stored URLs tagged as trash.

24. The method of claim 23, wherein the omitted search results are not rendered in the web browser.
